(19) United States
(12) Patent Application Publication
(10) Pub. No.: US 2013/0225116 A1
(43) Pub. Date: Aug. 29, 2013

(54) METHOD FOR NOTIFYING EMERGENCY BY MOBILE DEVICE AND HEALTH CARE MODULE AND HEALTH CARE SYSTEM USING THE SAME

(71) Applicants: Hyun Woo KIM, Seoul (KR); Jae Gi SON, Seongnam-si (KR); Ki Man JEON, Seongnam-si (KR)

(72) Inventors: Hyun Woo KIM, Seoul (KR); Jae Gi SON, Seongnam-si (KR); Ki Man JEON, Seongnam-si (KR)

(73) Assignee: KOREA ELECTRONICS TECHNOLOGY INSTITUTE, Seongnam-si (KR)

(21) Appl. No.: 13/403,053

(22) Filed: Feb. 23, 2012

(51) Int. Cl. H04W 4/22

(52) U.S. Cl. 455/404.2

(57) ABSTRACT

A method for notifying an emergency and a health care system using the same are provided. The method includes receiving, at a mobile device, user health information from a module mounted to the mobile device; storing, at the mobile device, the received user health information; and when receiving an emergency signal from the mounted module, sending, at the mobile device, user location information and the stored user health information. Since the present invention can be implemented using a user's mobile device and a small module of low price, the user can avoid the financial burden and does not have to carry along a separate health care device.

### TECHNICAL FIELD OF THE INVENTION

The present invention relates generally to a health care system. More particularly, the present invention relates to a method for notifying an emergency of a user to a medical institution, and a health care system using the same.

### BACKGROUND OF THE INVENTION

In recent, as the lifespan of human expands thanks to improvement of the living environment and advances of medical technology, the population ageing emerges as a social problem. In relation with the population ageing, intention and demand for the health care are rapidly increasing.

Meanwhile, the rapid process of communication technology and mobile platform grafts the electronic technology onto the health care, and thus a lot of health care devices are created.

However, most of the health care devices are expensive and thus imposes a financial burden on users. Also, a separate device should be carried along, which can be inconvenient to the user.

### SUMMARY OF THE INVENTION

To address the above-discussed deficiencies of the prior art, it is a primary aspect of the present invention to provide a method for receiving and storing health information through a module mounted to a mobile device, recognizing an emergency of a user, and notifying the emergency to a medical institution, and a health care system using the same.

According to one aspect of the present invention, a method for notifying an emergency includes receiving, at a mobile device, user health information from a module mounted to the mobile device; storing, at the mobile device, the received user health information; and when receiving an emergency signal from the mounted module, sending, at the mobile device, user location information and the stored user health information.

The method may further include when the user presses a button of the module, generating and sending, at the module, the emergency signal to the mobile device.

The method may further include collecting, at the module, the user health information from an external device; generating, at the module, the user health information using a measurer of the module; and sending, at the module, the collected user health information and the generated user health information to the mobile device.

The sending operation may include sending, at the mobile device, the user location information and the user health information to a medial institution.

The method may further include receiving, at the mobile device, first aid information from the medical institution and providing the first aid information to the user.

The method may further include periodically sending, at the mobile device, the stored user health information to a medical institution; and when receiving an examination guide from the medical institution, providing, at the mobile device, the examination guide to the user.

The module may be detachable from the mobile device.

A health care system includes a module mounted to a mobile device, for sending user health information and an emergency signal to the mobile device; and the mobile device for receiving and storing the user health information from the module, and sending user location information and the stored user health information to a medical institution when the emergency signal is received from the module.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of a health care system according to an exemplary embodiment of the present invention;

FIG. 2 is a detailed block diagram of a health care module of FIG. 1; and

FIG. 3 is a sequence chart of a method for notifying an emergency according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents.

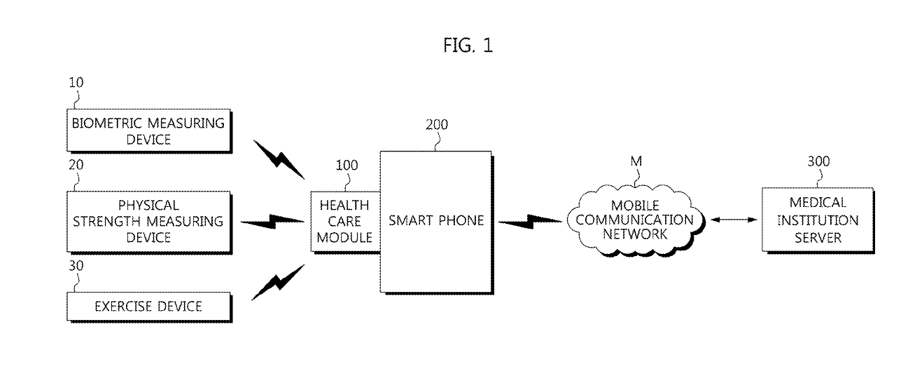

FIG. 1 is a diagram of a health care system according to an exemplary embodiment of the present invention. As shown in FIG. 1, the health care system is constructed by communicatively connecting devices 10, 20 and 30, a health care module 100, a smart phone 200, and a medical institution server 300.

In detail, the devices 10, 20 and 30 and the health care module 100 are wirelessly connected for their mutual communication. The health care module 100 and the smart phone 200 are physically/electrically connected for their mutual communication. The smart phone 200 and the medial institution server 300 are connected over a mobile communication network M for their mutual communication.

A biometric measuring device 10 generates biological information by measuring a height, a weight, a blood pressure, and blood sugar of a user. The biometric measuring device 10 can be implemented using a single device or a plurality of devices.

A physical strength measuring device 20 generates physical strength information by measuring muscular power, endurance, and reflexes of the user. Similar to the biometric measuring device 10, the physical strength measuring device 20 can be implemented using a single device or a plurality of devices.

An exercise device 30 is used for the exercise of the user, and generates exercise information by measuring the amount of the exercise of the user. Similar to the biometric measuring device 10 and the physical strength measuring device 20, the exercise device 30 can be implemented using a single device or a plurality of devices.

The health care module 100 can be attached and detached to and from the smart phone 200, and wirelessly collects the biological information, the physical strength information, and the exercise information from the devices 10, 20 and 30. In addition, the health care module 100 can generate the biological information by directly measuring the blood pressure and the blood sugar.

The health care module 100 forwards the collected/generated health information (the biological information, the physical strength information, and the exercise information) to the smart phone 200.

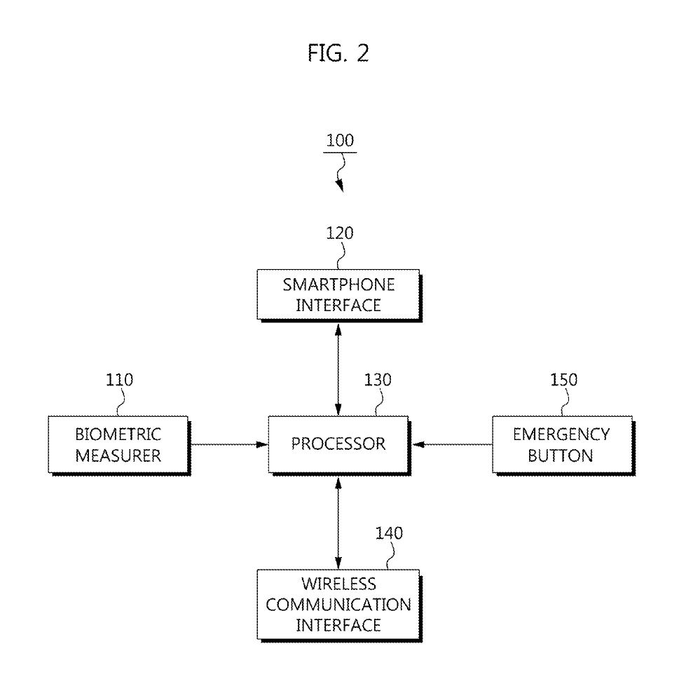

FIG. 2 is a detailed block diagram of the health care module 100 of FIG. 1. As shown in FIG. 2, the health care module 100 includes a biometric measurer 110, a smartphone interface 120, a processor 130, a wireless communication interface 140, and an emergency button 150.

The biometric measurer 110 generates the biological information by measuring the user's blood pressure and blood sugar, and provides the generated biological information to the processor 130 to be explained.

The smartphone interface 120 includes a connecter for physically connecting to the smart phone 200, and provides a communication interface for transmitting and receiving messages and information to and from the smart phone 200.

The wireless communication interface 140 provides a communication interface for wirelessly transmitting and receiving messages and information to and from the devices 10, 20 and 30.

The emergency button 150 is pressed when an emergency takes place. The user uses the emergency button 150 to input a first aid request when the user feels sick and requires the emergency treatment.

The processor 130 forwards the health information from the biometric measurer 110 and the wireless communication interface 140, to the smart phone 200 via the smartphone interface 120.

When the user inputs the emergency request (that is, when the emergency button 150 is pressed), the processor 130 generates an emergency signal and sends the generated emergency signal to the smart phone 200 via the smartphone interface 120, to thus notify the emergency.

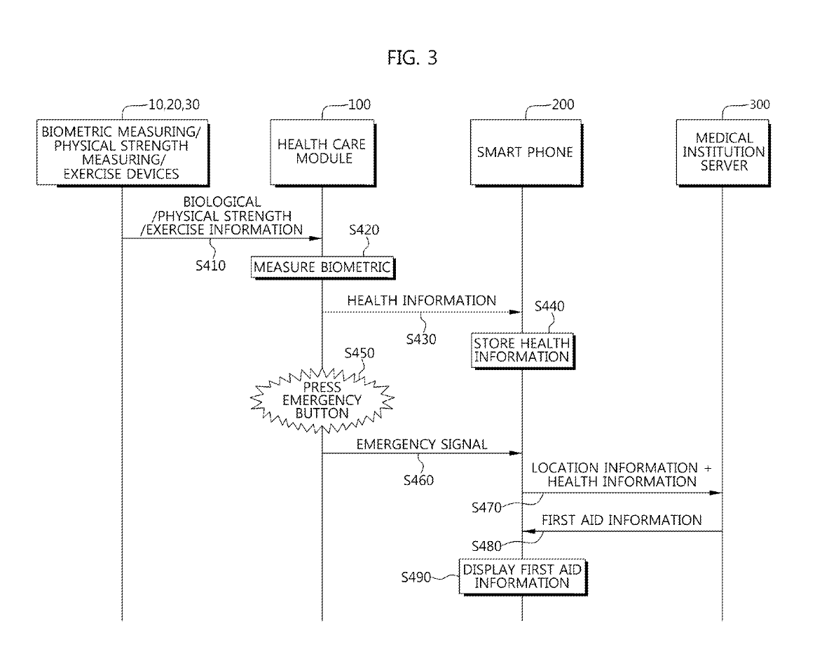

Referring back to FIG. 1, the smart phone 200 stores the health information received from the health care module 100. Meanwhile, when receiving the emergency signal from the health care module 100, the smart phone 200 notifies the emergency to the medical institution server 300 over the mobile communication network N, which is explained in detail by referring to FIG. 3.

FIG. 3 is a sequence chart of a method for notifying an emergency according to an exemplary embodiment of the present invention.

As shown in FIG. 3, the wireless communication interface 140 of the health care module 100 collects the biological information, the physical strength information, and the exercise information of the user from the devices 10, 20 and 30 (S410), and the biometric measurer 110 generates the biological information of the user by itself (S420).

The processor 130 of the health care module 100 forwards the user's health information (the biological information, the physical strength information, and the exercise information) collected/generated in S410 and S420 to the smart phone 200 through the smartphone interface 120 (S430).

The smart phone 200 stores the user's health information received in S430 (S440).

Meanwhile, when the emergency happens to the user and the emergency button 150 of the health care module 100 is pressed (S450), the processor 130 generates and sends the emergency signal to the smart phone 200 through the smartphone interface 120 (S460).

Upon receiving the emergency signal in S460, the smart phone 200 sends user's location information and the stored health care information of the user to the medical institution server 300 over the mobile communication network M (S470).

The user's location information can be measured using a Global Positioning System (GPS) satellite signal. When the smart phone 200 does not include a GPS module, it can measure the user's location information using a base station signal.

The medical institution recognizing the emergency of the user in S470, can dispatch an ambulance to the user location to carry the user to a hospital.

The medical institution server 300 generates first aid information based on the user's health information received in S470, and sends the generated first aid information to the smart phone 200 (S480).

The smart phone 200 can display the first aid information received S480 in a display so that the user can see it (S490). If necessary, the smart phone 200 may provide the first aid information received in S480 as the sound through a speaker.

So far, the health care system and the method for notifying the emergency using this system have been explained in detail.

In the above embodiment, when the emergency happens to the user and the emergency button 150 of the health care module 100 is pressed, the smart phone 200 transmits the user's health information to the medical institution server 300 by way of example.

Alternatively, the smart phone 200 can periodically transmit the stored user's health information to the medical institution server 300. In so doing, when the user's health information is analyzed and the examination is necessary, the medical institution server 300 can send an examination guide message to the smart phone 200 to send it to the user.

Meanwhile, the smart phone 200 corresponds to a mere example of the mobile device carried along by the user, and can be replaced by other mobile device. For example, besides the smart phone 200, the present invention can be applied to a mobile device such as mobile PC, PDA, DMB player, PMP, MP3 player, and e-book.

As set forth above, by means of the module mounted to the mobile device, the health information can be received and stored, and the user's emergency can be recognized and notified it to the medical institution. This can be implemented using a user's mobile device and a small module of low price. Thus, the user can avoid the financial burden and does not have to carry along a separate health care device.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for notifying an emergency, comprising:
receiving, at a mobile device, user health information from a module mounted to the mobile device;
storing, at the mobile device, the received user health information; and
when receiving an emergency signal from the mounted module, sending, at the mobile device, user location information and the stored user health information,
wherein the mounted module communicates with at least one device selected from the group consisting of a biometric measuring device, a physical strength measuring device, and an exercise device.

2. The method of claim 1, further comprising:
when the user presses a button of the module, generating and sending, at the module, the emergency signal to the mobile device.

3. The method of claim 1, further comprising:
collecting, at the module, the user health information from an external device;
generating, at the module, the user health information using a measurer of the module; and
sending, at the module, the collected user health information and the generated user health information to the mobile device.

4. The method of claim 1, wherein the sending operation comprises:
sending, at the mobile device, the user location information and the user health information to a medical institution.

5. The method of claim 4, further comprising:
receiving, at the mobile device, first aid information from the medical institution and providing the first aid information to the user.

6. The method of claim 1, further comprising:
periodically sending, at the mobile device, the stored user health information to a medical institution; and
when receiving an examination guide from the medical institution, providing, at the mobile device, the examination guide to the user.

7. The method of claim 1, wherein the module is detachable from the mobile device.

8. A health care system comprising:
a module mounted to a mobile device, for sending user health information and an emergency signal to the mobile device; and
the mobile device for receiving and storing the user health information from the module, and sending user location information and the stored user health information to a medical institution when the emergency signal is received from the module,
wherein the module communicates with at least one device selected from the group consisting of a biometric measuring device, a physical strength measuring device, and an exercise device.
